(19) United States
(12) Patent Application Publication
(10) Pub. No.: US 2014/0238269 A1
(43) Pub. Date: Aug. 28, 2014

(54) Optical Film

(71) Applicant: SK Innovation Co., Ltd., Seoul (KR)

(72) Inventors: Sang Yeup Lee, Daejeon (KR); Hye Jin Lee, Daejeon (KR); Jong Chae Kim, Daejeon (KR); Seok Won Kim, Daejeon (KR); Hyuk Jun Kim, Daejeon (KR); Ki Yup Kim, Daejeon (KR); Yong Gyun Cho, Daejeon (KR)

(73) Assignee: SK Innovation Co., Ltd., Seoul (KR)

(21) Appl. No.: 14/190,605

(22) Filed: Feb. 26, 2014

(30) Foreign Application Priority Data
Feb. 27, 2013 (KR) 10-2013-0020808

(51) Int. Cl. C08L 1/10

(52) U.S. Cl. CPC C08L 1/10
USPC 106/170.52; 568/718

(57) ABSTRACT

Disclosed is an optical film, and more particularly, an optical film having excellent mechanical physical properties and low vapor permeability.

### CROSS-REFERENCE TO RELATED APPLICATIONS

This application claims priority to Korean Patent Application No. 10-2013-0020808, filed Feb. 27, 2013, the disclosure of which is hereby incorporated in its entirety by reference.

### TECHNICAL FIELD

The present invention relates to an optical film, and more particularly, to an optical film having excellent mechanical physical properties and low vapor permeability.

### BACKGROUND

A cellulose acylate film having high strength and excellent flame retardancy has been used as various pictures or an optical material. As compared to the other polymer films, the cellulose acylate film has a low optical anisotropy to provide a relatively low retardation. Therefore, the cellulose acylate film has been used in a polarizing plate, and the like.

Improvement of mechanical properties and low vapor permeability in the cellulose acylate film have been demanded, and with a technology developed up to now, a thin film cellulose acylate film having a thin thickness may not be stably produced and vapor permeability may be high.

In order to improve mechanical properties and decrease vapor permeability of the cellulose acylate film, plasticizers having a long molecular chain have been added according to the related art. However, in the case of adding the plasticizers having a long molecular chain, since tangle of a polymer chain of the cellulose acylate is disturbed, it is difficult to improve mechanical properties. In addition, since the additives has low compatibility with the cellulose acylate resin, a bleeding out phenomenon occurs, such that there is a limitation in manufacturing an optical film having low haze.

Further, there is an attempt to apply additives including an aromatic ring which is a hydrophobic group; however, even though the additives include an aromatic ring, vapor permeability may not be reduced. In addition, definite mutual position relationship between the cellulose acylate resin and the additive including the aromatic ring is not defined but the cellulose acylate resin and the additive are randomly positioned in some cases, and in the case in which there are many aromatic rings, compatibility with the cellulose acylate resin is deteriorated, a bleeding out phenomenon may easily occur, absorption is generated in a short wavelength region, such that transmittance may be decreased.

In addition, as patents including a stretching process or additional heat treatment to achieve a desired object, there are Patent Documents such as Korean Patent Laid-Open Publication Nos. 10-2008-0013984 (Feb. 13, 2008), 10-2008-0009309 (Jan. 28, 2008), and the like. However, even though mechanical physical properties are improved and vapor permeability is decreased by the processes described in the above-listed Patent Documents, continuous quality management is necessary in order to maintain a predetermined level of quality, and cost for equipment investment is additionally needed, and a difficulty in deducing corresponding processing conditions may occur.

Therefore, it is required to control physical properties by adding additives rather than by improving mechanical physical properties and decreasing vapor permeability according to the above-described process.

### SUMMARY

An embodiment of the present invention is directed to providing an optical film having low vapor permeability and excellent mechanical physical properties by adding additives thereto.

In addition, an embodiment of the present invention is directed to providing an optical compensation sheet, an optical filter for a stereoscopic image, a polarizing plate, and a liquid crystal display device, including the optical film.

Further, an embodiment of the present invention is directed to providing a liquid crystal display device having little change in display characteristic depending on environmental humidity.

The present invention relates to an optical film having excellent mechanical physical properties and low vapor permeability.

In addition, the present invention relates to an optical film containing a cellulose acylate resin as a base material. The cellulose acylate resin may have a structure in which hydrogen atoms are substituted with acetate, propionate, butyrate, or single ester or plural esters selected therefrom, and some unsubstituted hydroxyl group has hydrophilic property to increase vapor permeability of the cellulose acylate optical film.

The present inventors studied to manufacture an optical film containing a cellulose acylate resin having excellent mechanical physical properties and low vapor permeability as a base material, and found that additives having hydrophobic property due to an aromatic ring and hydroxyl groups at ends of the aromatic ring are used to thereby deduce a hydrogen bonding with the hydroxyl group of the cellulose acylate resin, such that hydrophilic property of the cellulose acylate resin may be inhibited, and in addition, a hydrogen bonding with the hydroxyl group of the other cellulose acylate resin is deduced, such that mechanical properties may be improved, thereby completing the present invention.

In addition, the present inventors found that in the case in which the number of aromatic rings is three or more, the number of hydroxyl groups is two or more, and more preferably, the hydroxyl groups are positioned at both ends of the structure, the hydrogen bonding between the cellulose resins is deduced, such that mechanical strength and vapor permeability may be further improved, thereby completing the present invention.

In one general aspect, an optical film including a compound represented by the following Chemical Formula 1 is provided:

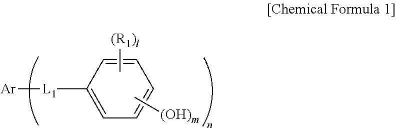

in Chemical Formula 1, n is 2 or 3, m is an integer selected from 1 to 3, l is an integer selected from 0 to 5, and m+l≦5,

Ar is selected from

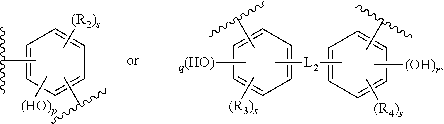

L₁ and L₂ are each independently selected from a bivalent linking group selected from —O—, —CO—, —OCO—, —COO—, —OCOO—, —O═S═O—, —COS—, —CONH—, —CSNH—, —O—CO—NH—, —O—CS—NH—, —CO(NH)₂—, and —CS(NH)₂—, (C₁-C₁₀)alkylene, (C₆-C₂₀) arylene, (C₂-C₁₀)alkenylene, (C₂-C₁₀)alkynylene, and (C₁-C₁₀)heteroalkylene and (C₆-C₂₀)heteroarylene including heteroatom selected from N, O, and S,

alkylene, arylene, alkenylene, alkynylene, heteroalkylene, heteroarylene of L₁ and L₂ are each further substituted with at least any one selected from (C₁-C₁₀)alkyl, ketone, sulfonyl, sulfonate, ester, thioester, amide, thioamide, carbamate, thiocarbamate, urea, and thiourea,

R₁ is each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₁ are further substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

R₂, R₃ and R₄ are each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₂, R₃ and R₄ are further substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

p, q and r are each independently 0 or 1, and

s is each independently an integer selected from 1 to 4.

The optical film may be used in an optical compensation sheet, an optical filter for a stereoscopic image, a polarizing plate, and a liquid crystal display device.

In another general aspect, a liquid crystal display device including the optical film as described above is provided.

### DETAILED DESCRIPTION OF EMBODIMENTS

Hereinafter, although the following embodiment of an optical film according to the present invention will be described, the present invention is not limited thereto.

In an embodiment of the optical film according to the present invention, the optical film includes a compound represented by the following Chemical Formula 1:

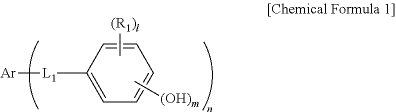

in Chemical Formula 1, n is 2 or 3, m is an integer selected from 1 to 3, l is an integer selected from 0 to 5, and m+l≦5,

Ar is selected from

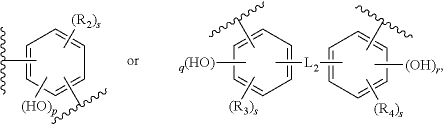

L₁ and L₂ are each independently selected from a bivalent linking group selected from —O—, —CO—, —OCO—, —COO—, —OCOO—, —O═S═O—, —COS—, —CONH—, —CSNH—, —O—CO—NH—, —O—CS—NH—, —CO(NH)₂—, and —CS(NH)₂—, (C₁-C₁₀)alkylene, (C₆-C₂₀) arylene, (C₂-C₁₀)alkenylene, (C₂-C₁₀)alkynylene, and (C₁-C₁₀)heteroalkylene, and (C₆-C₂₀)heteroarylene including heteroatom selected from N, O, and S,

alkylene, arylene, alkenylene, alkynylene, heteroalkylene, heteroarylene of L₁ and L₂ are each further substituted with at least any one selected from (C₁-C₁₀)alkyl, ketone, sulfonyl, sulfonate, ester, thioester, amide, thioamide, carbamate, thiocarbamate, urea, and thiourea,

R₁ is each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₁ are further substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

R₂, R₃ and R₄ are each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₂, R₃ and R₄ are substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

p, q and r are each independently 0 or 1, and

s is each independently an integer selected from 1 to 4.

In the embodiment of the optical film of the present invention, the Chemical Formula 1 may be selected from the following Chemical Formula 2 or Chemical Formula 3:

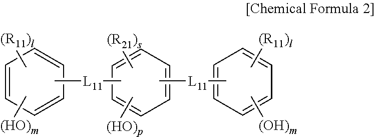

in Chemical Formula 2, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

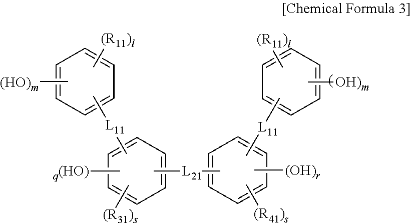

in Chemical Formula 3, m is an integer selected from 1 to 3, l is an integer selected from 0 to 5, and m+l≦5,

L₁₁ and L₂₁ are each independently (C₁-C₁₀)alkylene,

R₁₁, R₂₁, R₃₁ and R₄₁ are each independently selected from hydrogen and (C₁-C₁₀)alkyl,

q and r are each independently 0 or 1, and

s is each independently an integer selected from 1 to 4.

In the embodiment of the optical film of the present invention, the Chemical Formula 2 may be the following Chemical Formula 4 or Chemical Formula 5:

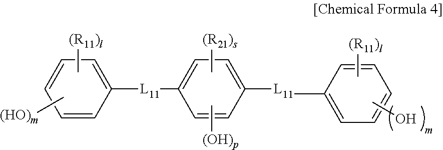

in Chemical Formula 4, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

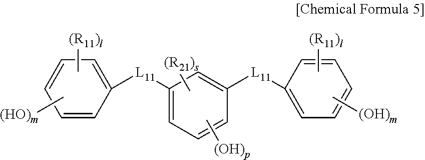

in Chemical Formula 5, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

In the embodiment of the optical film of the present invention, the Chemical Formula 2 may be selected from the following compounds:

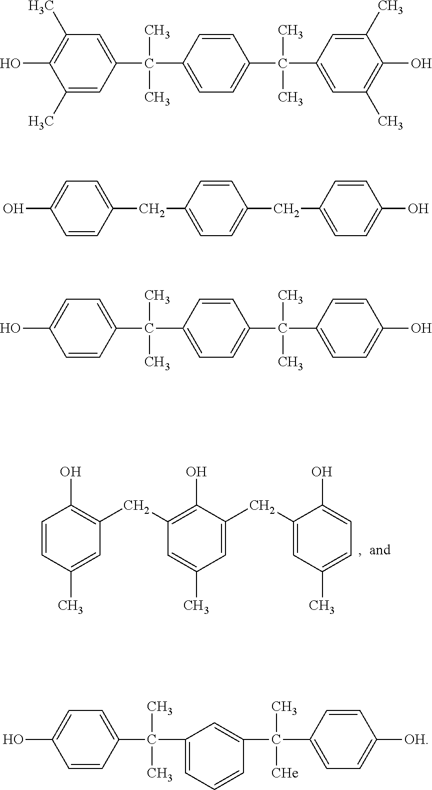

In the embodiment of the optical film of the present invention, the Chemical Formula 3 may be the following Chemical Formula 6:

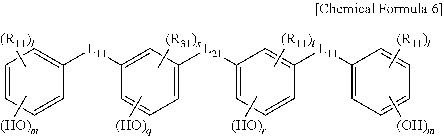

in Chemical Formula 5, m is an integer selected from 1 to 3, l is an integer selected from 0 to 5, and m+l≦5,

L₁₁ and L₂₁ are each independently (C₁-C₁₀)alkylene,

R₁₁, R₂₁, R₃₁ and R₄₁ are each independently selected from hydrogen and (C₁-C₁₀)alkyl,

q and r are each independently 0 or 1, and

s is each independently an integer selected from 1 to 4.

In the embodiment of the optical film of the present invention, the Chemical Formula 3 may be selected from the following compounds:

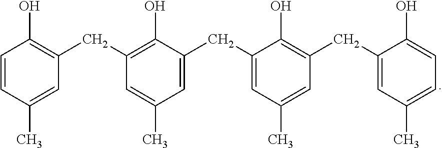 [SMILES: Cc1ccc(O)c(Cc2cc(C)cc(Cc3cc(C)cc(Cc4cc(C)ccc4O)c3O)c2O)c1]

In the embodiment of the optical film of the present invention, the compound represented by Chemical Formula 1 has a melting point of 100° C. or more, and a boiling point of 200° C. or more at an atmospheric pressure.

In the embodiment of the optical film of the present invention, the optical film may contain a cellulose acylate resin as a base material.

In the embodiment of the optical film of the present invention, a content of the compound represented by Chemical Formula 1 may be used in a range satisfying the following Equation 1:

$$A \times 0.05 \leq \frac{{W}_{HP}}{{M}_{HP}} \leq A \times 1.0 \qquad [ Equation 1 ]$$

in Equation 1, A is

$$\frac{{W}_{C} \times \{ 3 - ( {S}_{a c} + {S}_{p} + {S}_{b} ) \}}{159.12 + 43.04 {S}_{a c} + 57.07 {S}_{p} + 71.1 {S}_{b} + \{ 3 - ( {S}_{a c} + {S}_{p} + {S}_{b} ) \}} ,$$

Wc is a weight (g) of the used cellulose acylate resin, S_{ac} is a degree of substitution of acetyl group in the cellulose acylate resin, Sₚ is a degree of substitution of propionyl group, S_{b} is a degree of substitution of butyryl group, W_{HP} is a weight (g) of the compound selected from Chemical Formula 1, and M_{HP} is a molecular weight of the compound selected from Chemical Formula 1.

In the embodiment of the optical film of the present invention, the optical film may have vapor permeability less than 50,000 g·μm/m²·day at a thickness of 20 to 80 μm and have toughness of 1 to 3 kgf·mm/μm at a thickness of 1 μm.

In the embodiment of the optical film of the present invention, the optical film may be used in an optical compensation sheet, an optical filter for a stereoscopic image, a polarizing plate, and a liquid crystal display device.

As an embodiment of the optical compensation sheet according to the present invention, the optical compensation sheet may include an optically anisotropic layer formed on at least one surface of the optical film, wherein the optically anisotropic layer may contain a hybrid orientation-treated disk typed compound.

As an embodiment of the polarizing plate according to the present invention, the polarizing plate may include a polarizer; and at least one of the optical film and the optical compensation sheet. Here, the optical compensation sheet may include an optically anisotropic layer formed on at least one surface of the optical film, wherein the optically anisotropic layer may contain a hybrid orientation-treated disk typed compound.

As an embodiment of the liquid crystal display device according to the present invention, the liquid crystal display device may include a liquid crystal cell; and a polarizing plate disposed on at least one surface of the liquid crystal cell. Here, the polarizing plate may include a polarizer; and at least one of the optical film and the optical compensation sheet. In addition, the optical compensation sheet may include an optically anisotropic layer formed on at least one surface of the optical film, wherein the optically anisotropic layer may contain a hybrid orientation-treated disk typed compound.

Hereinafter, each configuration of the present invention will be described in detail.

It is defined that the optical compensation sheet in the present invention uses the optical film according to the present invention as a support and essentially has an optical compensation function. The optical compensation sheet according to the present invention preferably includes a function of a transparent protective film as a protection function of the polarizing plate.

The optical film according to the present invention may be made of a transparent resin, and more specifically, may contain a cellulose acylate resin as a base resin.

In the cellulose acylate resin used in the present invention which is an ester of cellulose and acetic acid, the hydrogen atom of hydroxyl groups present at positions 2, 3, and 6 of a glucose unit configuring cellulose in the cellulose acylate resin may be partially or entirely substituted with any one or two or more selected from an acetyl group, a propionyl group and a butyryl group. More preferably, the hydrogen atom of hydroxyl groups present at positions 2, 3, and 6 of a glucose unit configuring cellulose in the cellulose acylate resin may be partially or entirely substituted with an acetyl group. A specific example thereof may include diacetyl cellulose, triacetyl cellulose, and the like.

A degree of substitution of the cellulose acylate resin is not limited, but preferably, 2.0 to 3.0, and more preferably, 2.5 to 2.9. The degree of substitution may be measured according to D817-96R04 and D5897-96R07 of ASTM. In the case in which the degree of substitution is extremely high, the hydroxyl group is less distributed in a molecular structure, such that there is little possibility that the hydroxyl group is hydrogen-bonded with the compound represented by Chemical Formula 1 of the present invention, and desired physical properties in the range of the degree of substitution may not be achieved.

The range of a molecular weight of the cellulose acylate resin is not limited thereto; however, a weight average molecular weight thereof is preferably 200,000 to 350,000. In addition, a molecular distribution Mw/Mn (Mw is a weight average molecular weight, Mn is a number average molecular weight) of the cellulose acylate resin is preferably 1.4 to 1.8, and more preferably, 1.5 to 1.7.

The optical film according to the present invention is preferably manufactured by a solvent casting method using a cellulose acylate dope solution. According to the solvent casting method, a solution (dope) containing a cellulose acylate resin dissolved into a solvent is casted on a support and the solvent is evaporated to thereby manufacture a film.

As a raw material of the cellulose acylate dope solution, cellulose acylate particles are preferably used. Here, it is preferred that 90 wt % or more of the cellulose acylate particles has an average particle size of 0.5 to 5 mm. In addition, it is preferred that 50 wt % or more of the cellulose acylate particles have an average particle size of 1 to 4 mm.

It is preferred that the cellulose acylate particles have a shape similar to a spherical shape if possible, and the cellulose acylate particles are dried so that a moisture content is 2 wt % or less, more preferably, 1 wt % or less, and prepared as a dope solution.

To the cellulose acylate dope solution used in the solvent casting method, various additives, for example, a plasticizer, an ultraviolet inhibitor, a deterioration inhibitor, fine particles, an exfoliator, an infrared absorbing agent, optically anisotropic controlling agent, and the like, may be added depending on usages of each process. A specific kind of the additives is not limited as long as the additive is generally used in the corresponding field, but may be used, and a content of the additive is preferably used in a range in which physical properties of the film are not deteriorated. The time when the additives are added may be determined depending on a kind of the additive. A process of adding the additives may be performed at the end of the preparation of the dope solution.

The plasticizer is used to improve mechanical strength of the film, and in the case of using the plasticizer, time required for drying the film may be reduced. The plasticizer is not limited but may be used as long as the plasticizer is generally used, and an example thereof may include carboxylic acid ester selected from phosphoric acid ester, phthalic acid ester, and citric acid ester. An example of the phosphoric acid ester may include triphenyl phosphate (TPP), biphenyl diphenyl phosphate, tricresyl phosphate (TCP), and the like. An example of the phthalic acid ester may include dimethyl phthalate (DMP), diethyl phthalate (DEP), dibutyl phthalate (DBP), dioctyl phthalate (DOP), diphenyl phthalate (DPP) and diethyl hexyl phthalate (DEHP), and the like. An example of the citric acid ester may include o-acetyl triethyl citrate (OACTE), o-acetyl tributyl citrate (OACTB), and the like. An example of the other carboxylic acid ester may include butyl oleate, methyl acetyl lysine oleate, dibutyl sebacate and various trimellitic acid esters. Preferably, a phthalic acid ester (DMP, DEP, DBP, DOP, DPP, DEHP) plasticizer may be used. A content of the plasticizer may be 2 to 20 parts by weight, preferably, 5 to 15 parts by weight, based on 100 parts by weight of the cellulose acylate resin.

An example of the ultraviolet inhibitor may include hydroxy benzophenone-based compound, benzotriazole-based compound, salicylic acid ester-based compound, a cyanoacrylate-based compound, and the like. A content of the ultraviolet inhibitor may be 0.1 to 3 parts by weight, preferably, 0.5 to 2 parts by weight, based on 100 parts by weight of the cellulose acylate resin.

An example of the deterioration inhibitor may include an antioxidant, peroxide decomposer, a radical inhibitor, a metal deactivator, a deoxidizer, a light stabilizer (hindered amine and the like), and the like. In particular, a preferable example of the deterioration inhibitor may include butylated hydroxy toluene (BHT) and tribenzylamine (TBA). A content of the deterioration inhibitor may be 0.01 to 5 parts by weight, preferably, 0.1 to 1 parts by weight, based on 100 parts by weight of the cellulose acylate resin.

The fine particles are added in order to favorably maintain curl inhibition of the film, conveyance property, adhesion prevention in a roll shape or scratch resistance, and may be any one selected from an inorganic compound and an organic compound. For example, an example of the inorganic compound may include a compound containing silicon, silicon dioxide, titanium oxide, zinc oxide, aluminum oxide, barium oxide, zirconium oxide, strontium oxide, antimony oxide, tin-antimony oxide, calcium carbonate, talc, clay, calcined kaolin, calcined calcium silicate, hydrated calcium silicate, aluminum silicate, magnesium silicate, calcium phosphate, and the like, preferably, an inorganic compound containing silicon, zirconium oxide, and the like. The fine particles have an average primary particle size of 80 nm or less, preferably, 5 to 80 nm, and more preferably, 5 to 60 nm, and in particular, 8 to 50 nm may be the most preferred. In the case in which the average primary particle size is more than 80 nm, a surface smoothness of the film is damaged.

In addition, a wavelength dispersion regulator, and the like, may be further added as needed. The additives are not limited but may be used as long as they are generally used in the corresponding field.

In addition, any retardation additive may be further added in order to increase or decrease retardation as needed. The retardation additive is not limited but may be used as long as it is generally used to regulate retardation in the corresponding field. In general, the optical film which is applied to a VA mode liquid crystal display device may contain an additive increasing retardation and the optical film which is applied to an IPS mode liquid crystal display device may contain an additive decreasing retardation. The retardation additive has excellent compatibility with the compound represented by Chemical Formula 1 in a content of 1 to 15 wt %, more preferably, 3 to 10 wt % in the film, such that a bleeding phenomenon may not occur and image in high quality may be formed.

The cellulose acylate dope solution for manufacturing the optical film according to the present invention may contain at least any one compound selected from the following Chemical Formula 1 in order to decrease vapor permeability and improve mechanical physical properties.

The optical film of the present invention is manufactured as a film by using the dope solution containing the compound, such that the compound represented by the following Chemical Formula 1 is present in the film:

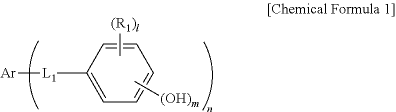

in Chemical Formula 1, n is 2 or 3, m is an integer selected from 1 to 3, l is an integer selected from 0 to 5, and m+l≦5,

Ar is selected from

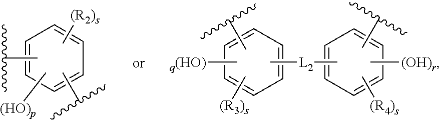

L₁ and L₂ are each independently selected from a bivalent linking group selected from —O—, —CO—, —OCO—, —COO—, —OCOO—, —O═S═O—, —COS—, —CONH—, —CSNH—, —O—CO—NH—, —O—CS—NH—, —CO(NH)₂—, and —CS(NH)₂—, (C₁-C₁₀)alkylene, (C₆-C₂₀) arylene, (C₂-C₁₀)alkenylene, (C₂-C₁₀)alkynylene, and (C₁-C₁₀)heteroalkylene, and (C₆-C₂₀)heteroarylene including heteroatom selected from N, O, and S,

alkylene, arylene, alkenylene, alkynylene, heteroalkylene, heteroarylene of L₁ and L₂ are each further substituted with at least any one selected from (C₁-C₁₀)alkyl, ketone, sulfonyl, sulfonate, ester, thioester, amide, thioamide, carbamate, thiocarbamate, urea, and thiourea,

R₁ is each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₁ are substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

R₂, R₃ and R₄ are each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,

alkyl and alkenyl of R₂, R₃ and R₄ are further substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea,

p, q and r are each independently 0 or 1, and

s is each independently an integer selected from 1 to 4.

The compound represented by Chemical Formula 1 of the present invention has at least three aromatic rings, and contains hydroxyl groups in two or more aromatic rings, more preferably, in aromatic rings at both ends thereof, thereby making it possible to be hydrogen-bonded with the hydroxyl group of the cellulose acylate resin, such that a film having significantly low vapor permeability and excellent mechanical physical properties may be provided.

A substituent including alkyl, alkoxy, and other alkyl portions described in the present invention includes both of a linear shape or a branched shape, and alkenyl includes a linear shape or a branched shape having 2 to 8 carbon atoms and at least one double bond. Alkynyl includes a linear shape or a branched shape having 2 to 10 carbon atoms and at least one triple bond.

Aryl described in the present invention, which is an organic radical derived from aromatic hydrogen carbon due to removal of one hydrogen, includes a monocyclic ring system or a fused ring system including 4 to 7 ring atoms, preferably, 5 or 6 ring atoms in each ring. A specific example of the aryl includes phenyl, naphthyl, biphenyl, tolyl, and the like, but the present invention is not limited thereto.

The heteroaryl described in the present invention indicates an aryl group including 1 to 3 heteroatom(s) selected from N, O, and S as an aromatic ring backbone atoms and carbon as remaining aromatic ring backbone atoms, wherein the heteroaryl group includes a bivalent aryl group forming N-oxide or a quartic salt due to oxidized or quaternised heteroatoms in the ring. A specific example of heteroaryl may include furyl, thiophenyl, pyrrolyl, pyranyl, imidazolyl, pyrazolyl, thiazolyl, thiadiazolyl, isothiazolyl, isoxazolyl, oxazolyl, oxadiazolyl, triazinyl, tetrazinyl, triazolyl, tetrazolyl, furazanyl, pyridyl, pyrazinyl, pyrimidinyl, pyridazinyl, and the like, but the present invention is not limited thereto.

(C3-C20) cycloalkyl described in the present invention includes both of a saturated monocyclic or a saturated bicyclic ring structure having 3 to 20 carbon atoms. In addition, polycyclic hydrocarbons such as substituted or unsubstituted adamantly or substituted or unsubstituted (C7-C20) bicycloalkyl in addition to a monocyclic hydrocarbon.

Hetero(C3-C20)cycloalkyl described in the present invention indicates a cycloalkyl group including 1 to 3 heteroatom(s) selected from N, O, and S as a saturated cyclic hydrocarbon backbone atom and carbon as remaining saturated monocyclic or bicyclic ring backbone atom, and may include pyrrolidinyl, azetidinyl, pyrazolidinyl, oxazolidinyl, piperidinyl, piperazinyl, morpholinyl, thiomorpholinyl, thiazolidinyl, hydantoinyl, valerolactamyl, oxiranyl, oxetanyl, dioxolanyl, dioxanyl, oxathiolanyl, oxathianyl, dithianyl, dihydrofuranyl, tetrahydrofuranyl, dihydropyranyl, tetrahydropyranyl, tetrahydropyridinyl, tetrahydropyrimidinyl, tetrahydrothiophenyl, tetrahydrothiopyranyl, diazepanyl, and azepanyl.

Specifically, the compound represented by Chemical Formula 1 according to an embodiment of the present invention may be selected from the following Chemical Formula 2 or Chemical Formula 3:

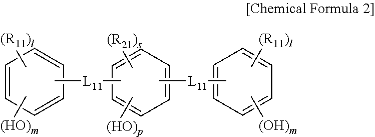

in Chemical Formula 2, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

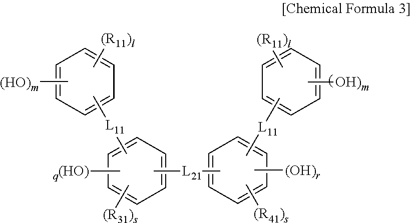

in Chemical Formula 3, m is an integer selected from 1 to 3, l is an integer selected from 0 to 5, and m+l≦5,

L₁₁ and L₂₁ are each independently (C₁-C₁₀)alkylene,

R₁₁, R₂₁, R₃₁ and R₄₁ are each independently selected from hydrogen and (C₁-C₁₀)alkyl,

q and r are each independently 0 or 1, and

s is each independently an integer selected from 1 to 4.

More specifically, the compound represented by Chemical Formula 2 may be selected from the following Chemical Formula 4 or 5:

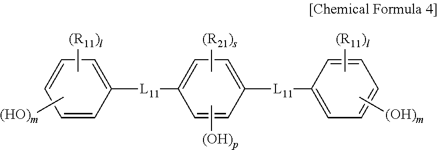

in Chemical Formula 4, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

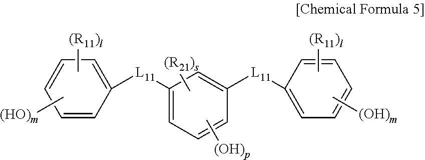

in Chemical Formula 5, m is an integer selected from 1 to 3, l is an integer selected from 0 to 5, and m+l≦5,

L₁₁ is each independently (C₁-C₁₀)alkylene,

R₁₁ is each independently selected from hydrogen and (C₁-C₁₀)alkyl,

R₂₁ is each independently selected from hydrogen and (C₁-C₁₀)alkyl,

p is 0 or 1, and

s is each independently an integer selected from 1 to 4.

More specifically, the compound represented by Chemical Formula 2 may be selected from the following compounds:

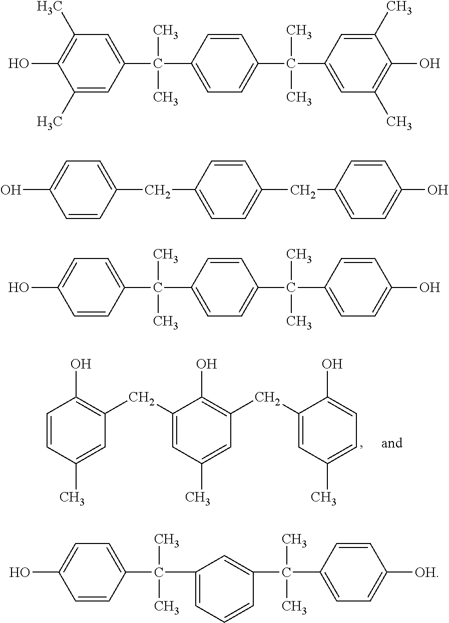

In the embodiment of the present invention, the Chemical Formula 3 may be the following Chemical Formula 6:

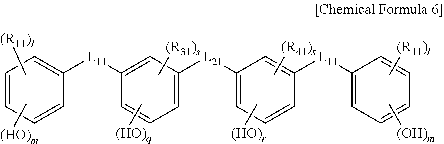

in Chemical Formula 6, m is an integer selected from 1 to 3, l is an integer selected from 0 to 5, and m+l≦5,

L₁₁ and L₂₁ are each independently (C₁-C₁₀)alkylene,

R₁₁, R₂₁, R₃₁ and R₄₁ are each independently selected from hydrogen and (C₁-C₁₀)alkyl,

q and r are each independently 0 or 1, and

s is each independently an integer selected from 1 to 4.

More specifically, the compound represented by Chemical Formula 3 may be selected from the following compounds:

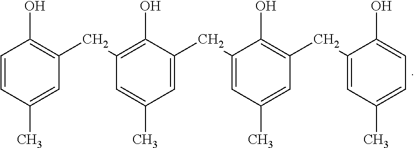 [SMILES: Cc1ccc(O)c(Cc2cc(C)cc(Cc3cc(C)cc(Cc4cc(C)ccc4O)c3O)c2O)c1]

The compound of the present invention having a melting point of 100° C. or more, and a boiling point of 200° C. or more at an atmospheric pressure is preferred since process stability at the time of forming a film is excellent. That is, in the above-described range, additives are not diffused or decomposed at a general drying temperature in a film manufacturing process, and high boiling point is preferred. The compound used in the present invention may provide a material having a boiling point of 200° C. or more due to introduction of aromatic ring and hydroxyl group.

In the optical film of the present invention, a content of the compound represented by Chemical Formula 1 may be used in a range satisfying the following Equation 1 or 2:

$$A \times 0.05 \leq \frac{{W}_{HP}}{{M}_{HP}} \leq A \times 1.0 \qquad [ Equation 1 ]$$

in Equation 1, A is

$$\frac{{W}_{C} \times \{ 3 - ( {S}_{a c} + {S}_{p} + {S}_{b} ) \}}{159.12 + 43.04 {S}_{a c} + 57.07 {S}_{p} + 71.1 {S}_{b} + \{ 3 - ( {S}_{a c} + {S}_{p} + {S}_{b} ) \}} ,$$

Wc is a weight (g) of the used cellulose acylate resin, S_{ac} is a degree of substitution of acetyl group in the cellulose acylate resin, Sₚ is a degree of substitution of propionyl group, S_{b} is a degree of substitution of butyryl group, W_{HP} is a weight (g) of the compound selected from Chemical Formula 1, and M_{HP} is a molecular weight of the compound selected from Chemical Formula 1.

$$\frac{{W}_{C} \times \{ 3 - {S}_{a c} ) \times 0.05}{159.12 + 43.04 {S}_{a c} + \{ 3 - {S}_{a c} \}} \leq \frac{{W}_{HP}}{{M}_{HP}} \leq \frac{{W}_{C} \times \{ 3 - {S}_{a c} ) \times 1.0}{159.12 + 43.04 {S}_{a c} + \{ 3 - {S}_{a c} )} \qquad [ Equation 2 ]$$

in Equation 2, Wc is a weight (g) of the used cellulose acylate resin, S_{ac} is a degree of substitution of acetyl group in the cellulose acylate resin, W_{HP} is a weight (g) of the compound selected from Chemical Formula 1, and M_{HP} is a molecular weight of the compound selected from Chemical Formula 1.

Specifically, a content of the compound represented by Chemical Formula 1 is affected by a degree of substitution of the cellulose acylate resin, and therefore, it is preferred that in the case in which the degree of substitution is extremely high, hydroxyl group has a small content, such that the compound represented by Chemical Formula 1 is used in a small content. More specifically, the content of Chemical Formula 1 is preferably 0.05 to 1.0 equivalent, more preferably, 0.1 to 0.8 equivalent, and most preferably, 0.2 to 0.6 equivalent with respect to the content of hydroxyl group of the cellulose acylate resin.

For reference, in the case of adding a material having a molecular weight of 400 g/mol with respect to the cellulose acylate resin having a degree of substitution of 2.87, 0.05 equivalent corresponds to 0.92 parts by weight, 0.1 equivalent, 0.3 equivalent, 0.5 equivalent, and 1.0 equivalent correspond to 1.84 parts by weight, 5.52 parts by weight, 9.19 parts by weight, and 18.39 parts by weight, respectively.

The optical film according to the present invention satisfies vapor permeability less than 50,000 g·μm/m²·day at a thickness of 20 to 80 μm and toughness of 1 to 3 kgf·mm/μm at a thickness of 1 μm. More specifically, the optical film according to the present invention satisfies vapor permeability of 30,000 to 49,000 g·μm/m²·day at a thickness of 40 to 80 μm and toughness of 1.5 to 2.6 kgf·mm/μm at a thickness of 1 μm.

In addition, the optical film according to the present invention may satisfy physical properties, that is, that modulus is 3.0 to 5 Gpa, tensile stress is 80 to 150 Mpa, more preferably, 94 to 110 Mpa, tensile strain is 10 to 30%, such that an optical film having significantly improved mechanical physical properties may be provided.

The vapor permeability, which is measured using a vapor permeability measuring device (PERMATRAN-W Model 3/33, manufactured by MOCON), is obtained by measuring moisture passing through a film from an external cell to be permeated into an inner cell under the following conditions, that is, pressure to be applied to a film sample is 760 mmHg, temperature is 37.8° C., relative humidity (RH) of the external cell is 100% and N₂ carrier gas.

The optical film satisfying the above-described range of vapor permeability may prevent a polarizer from being damaged at the time of manufacturing a polarizing plate. More specifically, the vapor permeability is a physical property which is affected at the time of manufacturing a polarizing plate, and in the case in which the optical film is used as a protective film, since a water-based adhesive is generally used at the time of adhering the optical film to a polarizer, moisture used in adhesion after the optical film and the polarizer are bonded should be discharged to the outside and removed to thereby prevent the polarizer from being damaged, such that it is preferable to have an appropriate moisture transmittance. Therefore, in the above-described range of vapor permeability, the optical film having excellent subsequent process is preferably provided.

In addition, the optical film satisfying the above-described range may react to change in surrounding humidity at the time of being applied to an optical compensation sheet, a polarizer, and a liquid crystal display device, thereby making it possible to decrease change in display properties.

The modulus, tensile stress, tensile strain, and toughness are measured under measuring conditions according to ASTM D882-02 after samples are manufactured by a scheme according to ASTM D6287-09, and universal tensile tester (UTM) 3345 Model manufactured by Instron is used as the measuring instrument. More specifically, at least three thicknesses in the total area of a film sample for tensile test having a length of 15 mm and a width of 100 mm are measured and an average thereof is calculated and a thickness deviation should be less than 10%. The thus-prepared sample is loaded on UTM 3345 Model instrument manufactured by Instron. The sample loading is performed by coupling the film with upper and lower jawfaces of the UTM using compression air, wherein tension of the sample before tensile stress is applied should be constant. In addition, tensile stress is provided by allowing upper and lower jawfaces to be spaced apart from each other, and mechanical properties until being fractured are collected by the UTM instrument. In the case in which a spacing rate is set to be 50 mm/min and tensile stress is instantly decreased to 40% or less due to the fracture, the spacing is terminated. Young's Modulus, fracture tensile stress, fracture tensile strain, and toughness values are calculated from a data regarding tensile stress and tensile strain which is collected every single moment up to the fracture. Since mechanical physical properties are excellent in toughness value of 1 to 3 kgf·mm/μm (as compared to the cellulose acylate film manufactured according to the existing method), the manufactured film is stable against fracture or shock at the time of manufacturing a film, such that processability may be excellent, which is advantages for improving modulus due to stretching. In addition, the toughness is nonlinearly increased depending on a thickness, which is considered that the reason is because a ratio between film surface and an inner portion of the film varies depending on a thickness. That is, a film having a relatively thick thickness has a relatively large toughness value since an inner portion of the stable film is high, as compared to a film having a relatively thin thickness. That is, it is considered that the toughness value is affected by thickness of the film as well as material properties of the film. Therefore, even though the cellulose acylate film has the same toughness value per μm unit, as a thickness thereof becomes thicken, the toughness value tends to be slightly increased. When comparing the cellulose acylate film according to the present invention with the existing cellulose acylate film according to the related art, each having same thickness in view of measured toughness value, the toughness value of the cellulose acylate film according to the present invention is improved up to about 30%, which shows that mechanical physical properties are significantly excellent.

Then, a method of manufacturing an optical film according to the present invention will be described. The optical film of the present invention may be a cellulose acylate film using a cellulose acylate resin as a base resin. Hereinafter, a method of manufacturing the cellulose acylate film as an example of the present invention will be described.

In order to manufacture the cellulose acylate film in the present invention, the following cellulose acylate composition, that is, a dope solution is prepared.

The cellulose acylate composition according to an embodiment of the present invention includes the compound represented by Chemical Formula 1 as an additive for decreasing vapor permeability and improving mechanical strength in a range satisfying the following Equation 1 with respect to 100 parts by weight of the cellulose acylate resin, more specifically, 0.1 to 20 parts by weight, and more preferably, the compound of Chemical Formula 1 is used in 0.1 to 0.8 equivalent with respect to a content of hydroxyl group of the cellulose acylate resin:

$$A \times 0.05 \leq \frac{{W}_{HP}}{{M}_{HP}} \leq A \times 1.0 \qquad [ Equation 1 ]$$

in Equation 1, A is

$$\frac{{W}_{C} \times \{ 3 - ( {S}_{a c} + {S}_{p} + {S}_{b} ) \}}{159.12 + 43.04 {S}_{a c} + 57.07 {S}_{p} + 71.1 {S}_{b} + \{ 3 - ( {S}_{a c} + {S}_{p} + {S}_{b} ) \}} ,$$

Wc is a weight (g) of the used cellulose acylate resin, S_{ac} is a degree of substitution of acetyl group in the cellulose acylate resin, Sₚ is a degree of substitution of propionyl group, S_{b} is a degree of substitution of butyryl group, W_{HP} is a weight (g) of the compound selected from Chemical Formula 1, and M_{HP} is a molecular weight of the compound selected from Chemical Formula 1.

A weight ratio with respect to the cellulose acylate is determined depending on a molecular weight of the compound represented by Chemical Formula 1. In the case in which a cellulose acetate having a degree of substitution of 2.87 is used as a base material resin and a compound having a general molecular weight of 400 g/mol has an extremely small content, it is difficult to effectively achieve the desired vapor permeability and mechanical strength, and on the contrary, in the case in which the compound has an extremely large content, side effects such as interaction between compounds represented by Chemical Formula 1 or bleeding out from the cellulose acylate may occur. It is considered in the above-described range that as the content is generally increased, decrease in vapor permeability and improvement of mechanical strength are proportionally increased. In addition, in the case of using the compound in the above-described range, the desired vapor permeability and mechanical strength may be achieved.

A solid concentration of the dope in the present invention is preferably 15 to 25 wt %, and more preferably, 16 to 23 wt %. In the case in which the solid concentration of the dope is less than 15 wt %, since fluidity is extremely high, it is difficult to manufacture a film, and in the case in which the solid concentration of the dope is more than 25 wt %, it is difficult to perform complete dissolution.

In an embodiment of the present invention, a content of the cellulose acylate is 70 wt % or more based on the total solid content, preferably, 70 to 90 wt %, and more preferably, 80 to 85 wt %. In addition, the cellulose acylate may be used by mixing two kinds or more cellulose acylate having degree of substitution, degree of polymerization or molecular weight distribution different from each other.

In the case of manufacturing a film by a solvent casting method, a solvent for preparing the cellulose acylate composition (dope) is preferably an organic solvent. As the organic solvent, halogenated hydrocarbon is preferably used, and an example of the halogenated hydrocarbon includes chlorinated hydrocarbon, methylene chloride, and chloroform, and among them, methylene chloride is the most preferred.

In addition, a solvent obtained by mixing organic solvents rather than halogenated hydrocarbon may be used as needed. An example of the organic solvent rather than halogenated hydrocarbon may include ester, ketone, ether, alcohol, and hydrocarbon. An example of the ester may include methyl formate, ethyl formate, propyl formate, pentyl formate, methyl acetate, ethyl acetate, pentyl acetate, and the like, an example of the ketone may include acetone, methyl ethyl ketone, diethyl ketone, diisobutyl ketone, cyclopentanone, cyclohexanone, methyl cyclohexanone, and the like, an example of the ether may include diisopropyl ether, dimethoxymethane, dimethoxyethane, 4-dioxane, 1,3-dioxolane, tetrahydrofuran, anisole, phenetol, and the like, and an example of the alcohol may include methanol, ethanol, 1-propanol, 2-propanol, 1-butanol, 2-butanol, t-butanol, 1-pentanol, 2-methyl 2-butanol, cyclohexanol, 2-fluoroethanol, 2,2,2-trifluoroethanol, 2,2,3,3-tetrafluoro-1-propanol, and the like.

More preferably, methylene chloride may be used as a main solvent, and alcohol may be used as a side-solvent. Specifically, methylene chloride and alcohol may be mixed in weight ratio of 80:20 to 95:5.

The cellulose acylate composition may be prepared according to room temperature, high temperature and low temperature dissolution method.

A viscosity of the cellulose acylate composition is preferably 1 to 400 Pa·s at 40° C., more preferably, 10 to 200 Pa·s.

The cellulose acylate film may be manufactured by a general solvent casting method. More specifically, the prepared dope (cellulose acylate composition) is first stored in storage and foams contained in the dope are defoamed. The defoamed dope is moved from a dope outlet through a pressurized quantitative gear pump capable of transferring a fixed quantity of liquid with high degree of precision according to the number of rotation to a pressurized die, the dope is uniformly casted on an endlessly moved metal support from a mold (slit) of the pressurized die, and the casting film which is not completely dried is peeled from the metal support at a peeled point at which the metal support spines around. Both ends of the manufactured web are inserted into a clip and conveyed to a tenter while maintaining width thereof and dried, and the dried material is conveyed to a roller of a drying apparatus and dried and then wound so as to have a predetermined length by a winder. In addition, at the time of manufacturing the casting film, the film may be uniaxially and biaxially stretched in a machine direction and a width direction in a state in which a residual solvent amount is 10 to 40 wt %. Otherwise, after the casting film is manufactured, the film may be stretched in an offline. The film may be stretched in a machine direction or a width direction or biaxially stretched in a simultaneous scheme or a sequential scheme. A degree of stretch is preferably 0 to 100% (wherein % indicates a length %), specifically, 0.1 to 100%, more preferably, 0 to 50%, and the most preferably, 5 to 30% in the degree of stretch indicates a length %, for example, 100% degree of stretch with respect to a film having the total length of 1 m before being stretched indicates that the length of the film is stretched to be 2 m.

A temperature of the stretch is preferably a glass transition temperature (T_{g})±10° C. of the optical film including compound represented by Chemical Formula 1. A spatial temperature at the time of applying a solution is preferably −50° C. to 50° C., more preferably, −30° C. to 40° C., and most preferably, −20° C. to 30° C. The cellulose acetate solution applied at a low spatial temperature is instantly cooled on the support and a gel strength is improved, such that a film having a large amount of residual organic solvent is obtained. Therefore, the film may be peeled from the support in a short time without evaporating the organic solvent from the cellulose acylate. As a gas cooling a space, general air, nitrogen, argon, or helium may be used. A relative humidity is preferably 0 to 70%, more preferably, 0 to 50%.

A temperature of the support (casting part) applying the cellulose acylate solution is preferably −50° C. to 130° C., more preferably, −30° C. to 25° C., and most preferably, −20° C. to 15° C. In order to cool the casting part, cooled gas may be introduced into the casting part. A cooling device may be disposed in the casting part to cool a space. In cooling the space, it is important to be cautious so that water is not attached to the casting part. In the case of cooling with a gas, it is preferred that the gas is prepared in a dried state.

In addition, a surface-treatment may be performed on the cellulose acylate film as needed. The surface-treatment is generally performed in order to improve adhesion of the cellulose acylate film. An example of the surface-treatment may include glow discharge treatment, ultraviolet irradiation treatment, corona treatment, flame treatment, saponification treatment, and the like.

A thickness of the cellulose acylate film is preferably 20 to 140 μm, more preferably, 20 to 80 μm.

The cellulose acylate film according to the present invention may be used in an optical compensation sheet, an optical filter for a stereoscopic image, a polarizing plate, and a liquid crystal display device and one sheet or two sheets or more thereof may be stacked.

More specifically, the cellulose acylate film according to the present invention may be used as a protective film of a polarizing plate. As an example of the polarizing plate of the present invention, the polarizing plate may include a polarizing film and two sheets of polarizing plate protective films protecting both surfaces thereof, wherein at least one sheet of the protective films may be the cellulose acylate film of the present invention.

In the case of using the cellulose acylate film of the present invention as the polarizing plate protective film, the cellulose acylate film may be surface-treated, wherein the surface-treatment may include glow discharge treatment, corona discharge treatment, alkaline saponification, and the like.

In general, since a liquid crystal cell in a liquid crystal display device is positioned between two sheets of polarizing plates, the liquid crystal display device has two sheets of polarizing plate protective films. The cellulose acylate film of the present invention may be used at any position of four sheets of polarizing plate protective films; however, the protective film positioned between the polarizing film and the liquid crystal cell of the liquid crystal display device is appropriate. The protective film position at an opposite side of the cellulose acylate film of the present invention may form a transparent hard coating layer, an antiglare coating layer, an anti-reflection coating layer, and the like.

An optical compensation film, or a liquid crystal display device having a polarizing plate including the cellulose acylate film according to the present invention is included in the range of the present invention. The cellulose acylate film according to the present invention may be used in a liquid crystal display device having various display modes, and a specific example of the display mode may include TN, IPS, FLC, AFLC, OCB, STN, ECB, VA, HAN, and the like.

Hereinafter, although Examples of the present invention have been disclosed for illustrative purposes in detail, the present invention is not limited to the following Examples.

Hereinafter, physical properties of the film were measured by the following methods.

1) Vapor Permeability

Vapor permeability was measured in a vapor permeability measuring device (PERMATRAN-W Model 3/33, manufactured by MOCON). Moisture passing through a film from an external cell to be permeated into an inner cell under the following conditions, that is, pressure to be applied to a film sample is 760 mmHg, temperature is 37.8° C., relative humidity (RH) of the external cell is 100% and N₂ carrier gas, for 24 hrs, was measured.

2) Degree of Substitution

A degree of substitution was measured according to D817-96R04 and D5897-96R07 of ASTM. An equipment used in the measuring was T50, T70 or T90 titrator manufactured by Mettler Toledo. Before a degree of substitution of cellulose acylate resin was measured, 30 ml of a solvent containing acetone and dimethyl sulfoxide (DMSO) in a volume ratio 4:1 was injected and a titration value was measured, and set as a standard. Then, about 0.35 to 0.4 g of cellulose acylate sample was added to 30 ml of a mixed solvent containing acetone and dimethyl sulfoxide (DMSO) in a volume ratio 4:1, the reactant was completely dissolved, and 6 ml of sodium hydroxide in 1 normal concentration was injected thereto. The reactant was stirred for 2 hours to be sufficiently dissociated and 30 ml of distilled water was injected and additionally stirred for about 3 minutes. The thus-prepared mixed solution was titrated with sulfuric acid in 1 normal concentration, and a final degree of substitution of the cellulose acylate was measured.

3) Mechanical Strength

Modulus, tensile stress, tensile strain, and toughness were measured by ASTM D 882-02.

The above-listed properties were measured using a cellulose acetate film sample having a size of 15 mm×100 mm manufactured according to ASTM D6287-09 by Universal type testing machine (Instron Corporation, 3345 Model) at room temperature.

### Example 1

### 1) Preparation of Cellulose Acetate Composition (Dope)

The following composition was put into a stirrer, and dissolved at a temperature of 30° C.

In the following compositions, 2-(2H-Benzotriazol-2-yl)-6-(1-methyl-1-phenylethyl)-4-(1,1,3,3-tetramethylbutyl)phenol was used as an ultraviolet (UV) inhibitor.

| | |
|---|---|
| Cellulose acetate powder having a degree of | 100 parts by weight |
| substitution of 2.87 | |
| Compound 1 | 10 parts by weight |
| UV inhibitor | 2 parts by weight |
| Silicon dioxide, average particle size of 16 nm | 0.5 parts by weight |
| Methylene chloride | 440 parts by weight |
| Methanol | 50 parts by weight |

The obtained dope was warmed to 30° C., transferred to a gear pump, filtered by a filter bed having an absolute filtering precision of 0.01 mm, and then again filtered by a cartridge filtering apparatus having an absolute filtering precision of 5 μm.

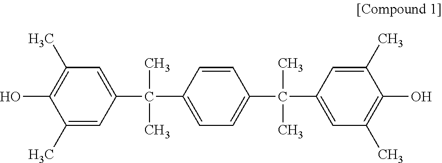 [SMILES: Cc1cc(C(C)(C)c2ccc(C(C)(C)c3cc(C)c(O)c(C)c3)cc2)cc(C)c1O]

### 2) Manufacture of Cellulose Ester Film

The obtained dope through the filtering process was casted on a mirror surface stainless support through a casting die and peeled. An amount of remaining solvent at the time of peeling was adjusted to be 25 wt %. After being peeled, the film was 0% stretched in a proceeding direction in a stretching machine, connected to a tenter, and then, was 5% stretched in a width direction thereof. After the film came out of the tenter and each 150 mm of end portions at left and right sides of the film was removed. The film of which the end portions were removed was dried by a drier, both ends of the dried film were cut to so as to be 3 cm, and knurling process with a height of 100 μm was performed at 10 mm portion apart from the end portions, thereby winding the film in a roll shape. A dried thickness of the manufactured film was 76 μm. Physical properties were measured using the manufactured cellulose acetate film, and were shown in the following Table 1.

### Example 2

A film of Example 2 was manufactured by the same method as Example 1 above except for using the following Compound 2 instead of using Compound 1.

Physical properties of the manufactured film were measured and were shown in the following Table 1.

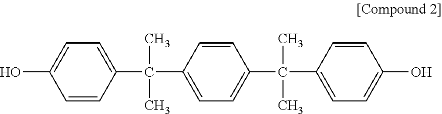 [SMILES: CC(C)(c1ccc(O)cc1)c1ccc(C(C)(C)c2ccc(O)cc2)cc1]

### Example 3

A film of Example 3 was manufactured by the same method as Example 1 above except for using the following Compound 3 instead of using Compound 1.

Physical properties of the manufactured film were measured and were shown in the following Table 1.

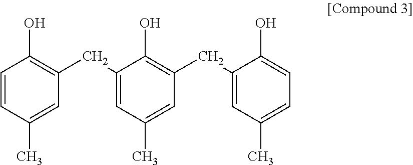 [SMILES: Cc1ccc(O)c(Cc2cc(C)cc(Cc3cc(C)ccc3O)c2O)c1]

### Example 4

A film of Example 4 was manufactured by the same method as Example 1 above except for using the following Compound 4 instead of using Compound 1.

Physical properties of the manufactured film were measured and were shown in the following Table 1.

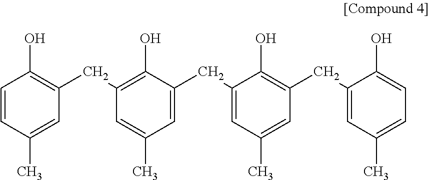 [SMILES: Cc1ccc(O)c(Cc2cc(C)cc(Cc3cc(C)cc(Cc4cc(C)ccc4O)c3O)c2O)c1]

### Example 5

### 1) Preparation of Cellulose Acetate Composition (Dope)

The following composition was put into a stirrer, and dissolved at a temperature of 30° C.

In the following compositions, 2-(2H-Benzotriazol-2-yl)-6-(1-methyl-1-phenylethyl)-4-(1,1,3,3-tetramethylbutyl)phenol was used as an ultraviolet (UV) inhibitor.

| | |
|---|---|
| Cellulose acetate powder having a substitution | 100 parts by weight |
| degree of 2.87 | |
| Compound 1 | 3 parts by weight |
| Triphenyl Phophate | 4 parts by weight |
| Biphenyldiphenyl Phophate | 4 parts by weight |
| UV inhibitor | 2 parts by weight |
| Silicon dioxide, average particle size of 16 nm | 0.5 parts by weight |
| Methylene chloride | 440 parts by weight |
| Methanol | 50 parts by weight |

The obtained dope was warmed to 30° C., transferred to a gear pump, filtered by a filter bed having an absolute filtering precision of 0.01 mm, and then again filtered by a cartridge filtering apparatus having an absolute filtering precision of 5 μm.

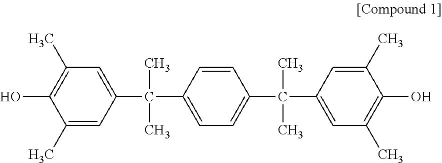 [SMILES: Cc1cc(C(C)(C)c2ccc(C(C)(C)c3cc(C)c(O)c(C)c3)cc2)cc(C)c1O]

### 2) Manufacture of Cellulose Ester Film

The obtained dope through the filtering process was casted on a mirror surface stainless support through a casting die and peeled. An amount of remaining solvent at the time of peeling was adjusted to be 25 wt %. After being peeled, the film was 0% stretched in a proceeding direction in a stretching machine, connected to a tenter, and then, was 5% stretched in a width direction thereof. After the film came out of the tenter and each 150 mm of end portions at left and right sides of the film was removed. The film of which the end portions were removed was dried by a drier, both ends of the dried film were cut to so as to be 3 cm, and knurling process with a height of 100 μm was performed at 10 mm portion apart from the end portions, thereby winding the film in a roll shape. A dried thickness of the manufactured film was 40 μm. Physical properties were measured using the manufactured cellulose acetate film, and were shown in the following Table 1.

### Comparative Example 1

### 1) Preparation of Cellulose Acetate Composition (Dope)

The following composition was put into a stirrer, and dissolved at a temperature of 30° C.

In the following compositions, 2-(2H-Benzotriazol-2-yl)-6-(1-methyl-1-phenylethyl)-4-(1,1,3,3-tetramethylbutyl)phenol was used as an ultraviolet (UV) inhibitor.

| | |
|---|---|
| Cellulose acetate powder having a substitution | 100 parts by weight |
| degree of 2.87 | |
| Triphenyl Phophate | 7 parts by weight |
| Biphenyldiphenyl Phophate | 4 parts by weight |
| UV inhibitor | 2 parts by weight |
| Silicon dioxide, average particle size of 16 nm | 0.5 parts by weight |
| Methylene chloride | 440 parts by weight |
| Methanol | 50 parts by weight |

The obtained dope was warmed to 30° C., transferred to a gear pump, filtered by a filter bed having an absolute filtering precision of 0.01 mm, and then again filtered by a cartridge filtering apparatus having an absolute filtering precision of 5 μm.

### 2) Manufacture of Cellulose Ester Film

The obtained dope through the filtering process was casted on a mirror surface stainless support through a casting die and peeled. An amount of remaining solvent at the time of peeling was adjusted to be 30 wt %. After being peeled, the film was 0% stretched in a proceeding direction in a stretching machine, and then, was 20% stretched in a width direction thereof. After the film came out of the tenter and each 150 mm of end portions at left and right sides of the film was removed. The film of which the end portions were removed was dried by a drier, both ends of the dried film were cut to so as to be 3 cm, and knurling process with a height of 100 μm was performed at 10 mm portion apart from the end portions, thereby winding the film in a roll shape. A dried thickness of the manufactured film was 76 μm. Physical properties were measured using the manufactured cellulose acetate film, and were shown in the following Table 1.

### Comparative Example 2

A film having a dried thickness of 40 μm was manufactured by the same method as Comparative Example 1 above.

Physical properties of the manufactured film were measured and were shown in the following Table 1.

TABLE 1

| | | Vapor | | Tensile | Tensile | Toughness |
|---|---|---|---|---|---|---|
| | Thickness | Permeability | Modulus | Stress | Strain | (kgf · mm/ |
| | (μm) | (g · μm/m² · day) | (Gpa) | (Mpa) | (%) | μm) |
| Comparative | 76 | 50,000 | 3.23 | 93.1 | 18.1 | 1.99 |
| Example 1 | | | | | | |
| Comparative | 40 | 50,000 | 3.73 | 84.5 | 14.5 | 1.63 |
| Example 2 | | | | | | |
| Example 1 | 76 | 29,000 | 3.61 | 101.5 | 17.5 | 2.07 |
| Example 2 | 76 | 41,000 | 3.46 | 98.5 | 21.7 | 2.60 |
| Example 3 | 76 | 42,000 | 3.47 | 100.2 | 20.6 | 2.51 |
| Example 4 | 76 | 38,000 | 3.62 | 106.4 | 17.1 | 2.18 |
| Example 5 | 40 | 42,500 | 4.03 | 94.2 | 15.1 | 1.88 |

It could be appreciated from Table 1 above that in Example using the additives according to the present invention, vapor permeability was remarkably improved, as compared to Comparative Example not using the additives. In addition, mechanical physical properties were excellent such that the cellulose acylate film having excellent process stability and high quality may be manufactured in the process of manufacturing the film.

The optical film according to the present invention may have low vapor permeability and excellent mechanical physical properties.

In addition, the optical film according to the present invention may be used as an optical film containing the cellulose acylate as PVA support, wherein the optical film may have low vapor permeability and excellent mechanical physical properties.

Further, the optical film which is appropriately used as a thin film used in an information display device having a thin thickness and a light weight may be provided.

What is claimed is:

1. An optical film including a compound represented by the following Chemical Formula 1: 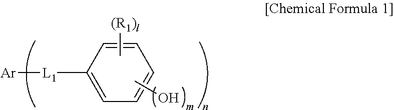
in Chemical Formula 1, n is 2 or 3, m is an integer selected from 1 to 3, l is an integer selected from 0 to 5, and m+l≦5,
Ar is selected from 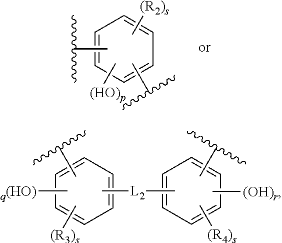
L₁ and L₂ are each independently selected from a bivalent linking group selected from —O—, —CO—, —OCO—, —COO—, —OCOO—, —O═S═O—, —COS—, —CONH—, —CSNH—, —O—CO—NH—, —O—CS—NH—, —CO(NH)₂—, and —CS(NH)₂—, (C₁-C₁₀)alkylene, (C₆-C₂₀) arylene, (C₂-C₁₀)alkenylene, (C₂-C₁₀)alkynylene, and (C₁-C₁₀)heteroalkylene, and (C₆-C₂₀)heteroarylene including heteroatom selected from N, O, and S,
alkylene, arylene, alkenylene, alkynylene, heteroalkylene, heteroarylene of L₁ and L₂ are each further substituted with at least any one selected from (C₁-C₁₀)alkyl, ketone, sulfonyl, sulfonate, ester, thioester, amide, thioamide, carbamate, thiocarbamate, urea, and thiourea,
R₁ is each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,
alkyl and alkenyl of R₁ are further substituted with at least any one selected from (C₁-C₁₀)alkyl, (C₆-C₂₀)aryl, ketone, sulfonyl, sulfonate, ester, thioester, amide, thioamide, carbamate, thiocarbamate, urea, and thiourea, R₂, R₃ and R₄ are each independently selected from hydrogen, (C₁-C₁₀)alkyl, (C₂-C₁₀)alkenyl, (C₂-C₁₀)alkynyl, (C₃-C₂₀)cycloalkyl, (C₂-C₁₀)cycloalkenyl, (C₂-C₁₀)cycloalkynyl, and (C₁-C₁₀)heteroalkyl, (C₆-C₂₀)heteroaryl, and (C₁-C₁₀)heteroalkoxy including heteroatom selected from N, O, and S,
alkyl and alkenyl of R₂, R₃ and R₄ are further substituted with at least any one selected from (C₁-C₁₀)alkyl, (C₆-C₂₀) aryl, ketone, sulfonyl, sulfonate, ester, thioester, amide, thioamide, carbamate, thiocarbamate, urea, and thiourea,
p, q and r are each independently 0 or 1, and
s is each independently an integer selected from 1 to 4.

2. The optical film of claim 1, wherein the Chemical Formula 1 is selected from the following Chemical Formula 2 or Chemical Formula 3: 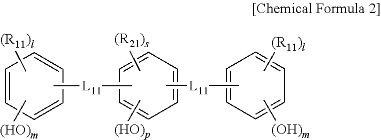
in Chemical Formula 2, m is an integer selected from 1 to 3, l is an integer selected from 0 to 5, and m+l≦5,
L₁₁ is each independently (C₁-C₁₀)alkylene,
R₁₁ is each independently selected from hydrogen and (C₁-C₁₀)alkyl,
R₂₁ is each independently selected from hydrogen and (C₁-C₁₀)alkyl,
p is 0 or 1, and
s is each independently an integer selected from 1 to 4 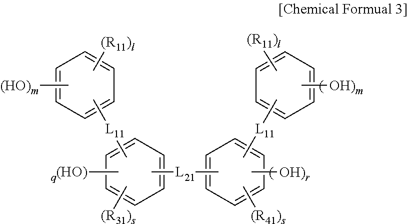
in Chemical Formula 3, m is an integer selected from 1 to 3, l is an integer selected from 0 to 5, and m+l≦5,
L₁₁ and L₂₁ are each independently (C₁-C₁₀)alkylene,
R₁₁, R₂₁, R₃₁ and R₄₁ are each independently selected from hydrogen and (C₁-C₁₀)alkyl,
q and r are each independently 0 or 1, and
s is each independently an integer selected from 1 to 4.

3. The optical film of claim 2, wherein the Chemical Formula 2 is the following Chemical Formula 4 or Chemical Formula 5: 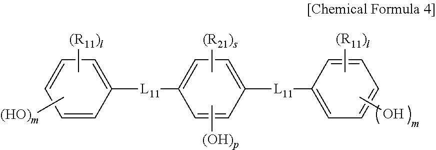
in Chemical Formula 4, m is an integer selected from 1 to 3, l is an integer selected from 0 to 5, and m+l≦5,
L₁₁ is each independently (C₁-C₁₀)alkylene,
R₁₁ is each independently selected from hydrogen and (C₁-C₁₀)alkyl,
R₂₁ is each independently selected from hydrogen and (C₁-C₁₀)alkyl,
p is 0 or 1, and
s is each independently an integer selected from 1 to 4 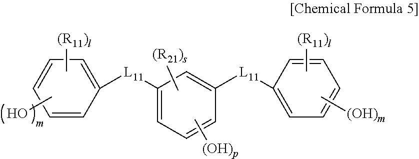
in Chemical Formula 5, m is an integer selected from 1 to 3, l is an integer selected from 0 to 5, and m+l≦5,
L₁₁ is each independently (C₁-C₁₀)alkylene,
R₁₁ is each independently selected from hydrogen and (C₁-C₁₀)alkyl,
R₂₁ is each independently selected from hydrogen and (C₁-C₁₀)alkyl,
p is 0 or 1, and
s is each independently an integer selected from 1 to 4.

4. The optical film of claim 2, wherein the Chemical Formula 2 is selected from the following compounds:

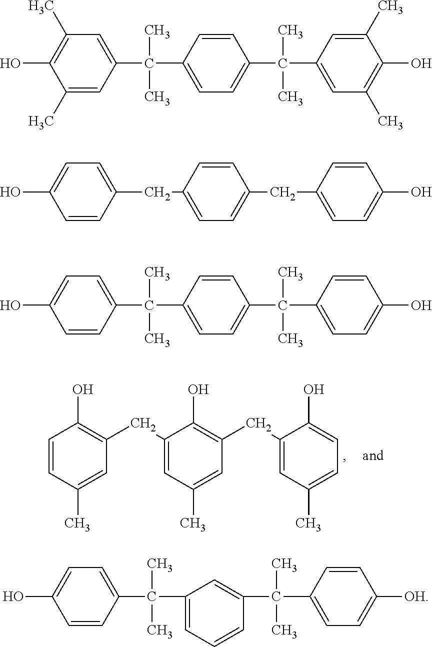

5. The optical film of claim 2, wherein the Chemical Formula 3 is the following Chemical Formula 6: 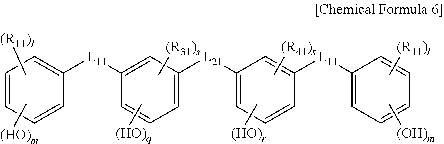
in Chemical Formula 6, m is an integer selected from 1 to 3, l is an integer selected from 0 to 5, and m+l≦5,
L₁₁ and L₂₁ are each independently (C₁-C₁₀)alkylene,
R₁₁, R₂₁, R₃₁ and R₄₁ are each independently selected from hydrogen and (C₁-C₁₀)alkyl,
q and r are each independently 0 or 1, and
s is each independently an integer selected from 1 to 4.

6. The optical film of claim 2, wherein the Chemical Formula 3 is selected from the following compound:

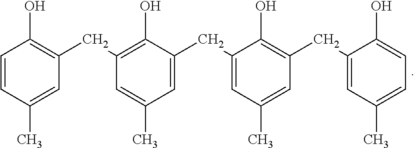 [SMILES: Cc1ccc(O)c(Cc2cc(C)cc(Cc3cc(C)cc(Cc4cc(C)ccc4O)c3O)c2O)c1]

7. The optical film of claim 1, wherein the compound represented by Chemical Formula 1 has a melting point of 100° C. or more, and a boiling point of 200° C. or more at an atmospheric pressure.

8. The optical film of claim 1, wherein the optical film contains a cellulose acylate resin as a base material.

9. The optical film of claim 8, wherein the hydrogen atom of hydroxyl groups present at positions 2, 3, and 6 of a glucose unit configuring cellulose in the cellulose acylate resin is partially or entirely substituted with any one or two or more selected from an acetyl group, a propionyl group and a butyryl group, and a degree of substitution according to ASTM D-817-91 is 2.0 to 3.0.

10. The optical film of claim 8, wherein a content of the compound represented by Chemical Formula 1 is used in a range satisfying the following Equation 1:
$$A \times 0.05 \leq \frac{{W}_{HP}}{{M}_{HP}} \leq A \times 1.0 \qquad [ Equation 1 ]$$
in Equation 1, A is
$$\frac{{W}_{C} \times \{ 3 - ( {S}_{a c} + {S}_{p} + {S}_{b} ) \}}{159.12 + 43.04 {S}_{a c} + 57.07 {S}_{p} + 71.1 {S}_{b} + \{ 3 - ( {S}_{a c} + {S}_{p} + {S}_{b} ) \}} ,$$
Wc is a weight (g) of the used cellulose acylate resin, S_{ac} is a degree of substitution of acetyl group in the cellulose acylate resin, Sₚ is a degree of substitution of propionyl group, S_{b} is a degree of substitution of butyryl group, W_{HP} is a weight (g) of the compound selected from Chemical Formula 1, and M_{HP} is a molecular weight of the compound selected from Chemical Formula 1.

11. The optical film of claim 1, wherein it has vapor permeability less than 50,000 g·μm/m²·day at a thickness of 20 to 80 μm and has toughness of 1 to 3 kgf·mm/μm at a thickness of 1 μm.

12. The optical film of claim 1, wherein it is used in an optical compensation sheet, an optical filter for a stereoscopic image, a polarizing plate, and a liquid crystal display device.

13. A liquid crystal display device including the optical film of claim 1.
